(19) United States
(12) Patent Application Publication
(10) Pub. No.: US 2026/0295677 A1
(43) Pub. Date: Oct. 1, 2026

(54) Medium manganese powder for additive manufacturing, printed part and method of manufacturing the same

(71) Applicant: ArcelorMittal, Luxembourg (LU)

(72) Inventors: Rosalía REMENTERIA FERNANDEZ, Aviles Asturias (ES); Manuel SANCHEZ PONCELA, Aviles Asturias (ES); Michel SOLER, Ars Laquenexy (FR); Astrid PERLADE, Le Ban-Saint-Martin (FR); Kangying ZHU, Metz (FR); Magali BOUZAT, Norroy-Le-Veneur (FR); Doriane SERRA, TALANGE (FR); Patrick BARGES, ROZERIEULLES (FR); Daniela OBRIOT, Batilly (FR)

(21) Appl. No.: 19/476,954

(22) PCT Filed: Apr. 12, 2024
(86) PCT No.: PCT/IB2024/053601

§ 371 Date: Oct. 20, 2025

(30) Foreign Application Priority Data
Apr. 28, 2023 (WO) PCT/IB2023/054421

(51) Int. Cl. B22F 10/28; B22F 1/05; B22F 9/08; B22F 10/366; B33Y 10/00; B33Y 70/00; B33Y 80/00; C22C 33/04; C22C 38/00; C22C 38/04

(52) U.S. Cl. CPC B22F 10/28; B22F 1/05; B22F 9/082; B22F 10/366; C22C 33/04; C22C 38/002; C22C 38/04; B22F 2009/088; B22F 2301/35; B22F 2304/10; B33Y 10/00; B33Y 70/00; B33Y 80/00

(57) ABSTRACT

A medium manganese powder for the manufacturing of steel parts and in particular for their additive manufacturing, and to the printed part having a composition including, by weight percent: C: 0.03-0.60%, Mn: 2.5-12.0%, O≤0.100%, P≤0.013%, S≤0.015%, N≤0.200% and including optionally one or more of the following elements, in weight percentage: Al≤1.0%, Mo≤0.65%, B≤0.004%, Si≤3%, Ti≤0.2%, Nb≤0.2%, V≤0.3%, Sn≤0.1%, Sb≤0.1%, Ni≤1.0%, Cr≤1.0%, Cu≤1.0% the remainder of the composition being iron and unavoidable impurities resulting from the elaboration.

The present invention relates to a medium manganese powder for the manufacturing of steel parts and in particular for their additive manufacturing. The present invention also relates to the printed part made of a medium manganese powder. The present invention relates also to the method of manufacture of the printed part.

### BACKGROUND

Ferrous alloy powders for additive manufacturing are usually being produced by an atomization process wherein fine metal droplets are obtained by forcing a molten alloy stream through a nozzle and by impinging it with jets of gas introduced into such stream just before it leaves the nozzle. Alloy droplets cool down during their fall in the atomizing tower, forming powder particles.

### SUMMARY OF THE INVENTION

The cooling rates that such powder particles are submitted to during their fall are not homogeneous from one particle to the other and can lead to the formation of unstable microstructures with heterogeneous fraction of phases and grain sizes.

When using such powder particles to manufacture a ferrous alloy part through additive manufacturing, the powders are subjected to complex thermal paths and the resulting parts can show heterogeneous microstructures due to time and temperature-dependent phase transformations, leading to inhomogeneous use properties. Moreover, the Laser Powder Bed Fusion (LPBF) process itself can also induce heterogenous microstructure in the printed part, due to the successive heating and cooling steps of all layers, in particular the last heating step at high temperature. In addition, the process parameters used in LPBF produce specific thermal paths, so that different microstructures and thus mechanical properties can be obtained in parts printed using different parameters.

It is an object of the present invention to solve the above-mentioned drawback and to provide a printed part by additive manufacturing, having a standard deviation of the nano-hardness values below or equal to 0.30 GPa.

Preferably, the part has an average nano-hardness above or equal to 4.0 GPa,

Another object of the present invention is to provide a method for manufacturing the printed part, with improved robustness over variations in the volumetric energy density (VED) used for printing the parts. In particular, it is aimed at having a variation of yield strength (YS) below or equal to 100 MPa, the variation of YS being calculated as the difference between the maximum value of YS and the minimum value of YS measured in at least two parts printed with different volumetric energy density (VED).

Preferably, the variation of YS is below or equal to 80 MPa.

The present invention provides a metal powder having a composition comprising the following elements, expressed in content by weight:

$$C : 0.03 - 0.6 \%$$

$$Mn : 2.5 - 12. \%$$

$$O \leq 0.1 \%$$

$$P \leq 0.013 \%$$

$$S \leq 0.015 \%$$

$$N \leq 0.2 \%$$

and comprising optionally one or more of the following elements, in weight percentage:

$$Al \leq 1. \%$$

$$Mo \leq 0.65 \%$$

$$B : \leq 0.004 \%$$

$$Si \leq 3 \%$$

$$Ti \leq 0.2 \%$$

$$Nb \leq 0.2 \%$$

$$V \leq 0.3 \%$$

$$Sn \leq 0.1 \%$$

$$Sb \leq 0.1 \%$$

$$Ni \leq 1. \%$$

$$Cr \leq 1. \%$$

$$Cu \leq 1. \%$$

the remainder of the composition being iron and unavoidable impurities resulting from the elaboration.

The present invention also provides a process for manufacturing a metal powder for additive manufacturing as described above, comprising:
a) Melting elements and/or metal-alloys at a temperature Th at least 100° C. above the liquidus temperature to obtain a molten composition as described above, and
b) Atomizing the molten composition through a nozzle with a gas pressurized from 10 to 30 bar.

The present invention also provides a printed part, made of a metal powder having a composition comprising, by weight percent:

$$C : 0.03 - 0.6 \%$$

$$Mn : 2.5 - 12. \%$$

$$O \leq 0.1 \%$$

$$P \leq 0.013 \%$$

$$S \leq 0.015 \%$$

$$N \leq 0.2 \%$$

and comprising optionally one or more of the following elements, in weight percentage:

$$Al \leq 1. \%$$

$$Mo \leq 0.65 \%$$

$$B \leq 0.004 \%$$

$$Si \leq 3 \%$$

$$Ti \leq 0.2 \%$$

$$Nb \leq 0.2 \%$$

$$V \leq 0.3 \%$$

$$Sn \leq 0.1 \%$$

$$Sb \leq 0.1 \%$$

$$Ni \leq 1. \%$$

$$Cr \leq 1. \%$$

$$Cu \leq 1. \%$$

the remainder of the composition being iron and unavoidable impurities resulting from the elaboration,
said printed part having a microstructure consisting, in surface fraction,
   from 5 to 50% of retained austenite,
   the rest being martensite and/or intercritical ferrite and/or bainite.

The present invention also provides a process for manufacturing a printed part as described above, comprising the following steps:
providing a metal powder as described above or obtained through the process as described above, and
printing by Laser Powder Bed Fusion.

### BRIEF DESCRIPTION OF THE DRAWINGS

The present invention will now be described in detail and illustrated by examples without introducing limitations, with reference to the appended FIGURES:

FIG. 1 illustrates the normalized frequency and the gaussian fit of the nano-hardness values of the printed parts.

### DETAILED DESCRIPTION

The composition of the powder according to the invention will now be described, the content being expressed in weight percent.

The carbon content is set at 0.03 to 0.60%. Carbon plays an important role in the formation of the microstructure of the final part, in particular in the formation of ferrite, bainite, martensite and retained austenite. Its main role is to provide strength and hardness. Carbon provides hardenability as well. However, carbon content above 0.60% will lead to downgraded printing properties. On the other hand, carbon content below 0.03% will not provide satisfactory strength. Preferably, the carbon content is of 0.03% to 0.50%, more preferably of 0.03% to 0.45%, even more preferably of 0.05% to 0.45%.

Manganese is present in the composition of the powder according to the invention at a content of 2.5% to 12.0%. Manganese is an essential alloying element to increase the hardenability of the steels and suppress transformed ferrite and cementite. Manganese will also prevent austenite decomposition during the successive heating and cooling steps at low temperature that will be experienced by the part during printing. The different printed layers will suffer less microstructural transformations from successive heating and cooling steps during the additive manufacturing process thereby keeping a more homogeneous microstructure. Manganese also contributes to strength and hardness. Preferably, the manganese content is of 2.5% to 11.0%, more preferably of 2.5% to 10.0%, even more preferably of 2.5% to 9.0%.

Optionally some elements can be added to the composition of the powder according to the invention.

Aluminum can be present in the composition according to the invention up to 1.0%, to reduce segregation of manganese during solidification and to improve toughness. Above 1.0% of aluminum, the printability of the part may be reduced. Preferably, the aluminum content is of 0.05% to 1.0%, or 0.2% to 1.0%, more preferably of 0.5% to 1.0%, even more preferably from 0.5% to 0.9%.

Molybdenum can be added at a content up to 0.65%. Molybdenum increases the hardenability of the steel and helps to reduce the tempering of the layers of melted powder during the printing process and thus to keep a homogeneous microstructure. Moreover, molybdenum helps to reduce the susceptibility of the steel to temper embrittlement and to increase toughness. Preferably, the molybdenum content can be added up to 0.50%, more preferably up to 0.40%, even more preferably up to 0.30%. Preferably the minimum amount of molybdenum can be of 0.05%, more preferably of 0.10%, even more of 0.15%.

Boron can optionally be added up to 0.004% in order to increase the hardenability and the toughness of the part. Preferably, the minimum content of boron is of 0.0002%.

Silicon may be optionally present in a content up to 3% in order to help to stabilize the retained austenite by inhibiting the precipitation of carbides. Silicon also increases the strength through solid solution strengthening without causing a loss in ductility. In a preferred embodiment, silicon is limited to 2%, or to 1% or even better to 0.5%.

Titanium and niobium may be optionally added up to 0.2% or to 0.1%, tin and antimony up to 0.1%, vanadium up to 0.3%, and nickel, copper and chromium up to 1.0% or up to 0.5% in order to achieve hardening and strengthening.

The balance is made of iron and unavoidable impurities resulting from the elaboration. Phosphorus, sulfur, nitrogen and oxygen are the main impurities. They are not deliberately added and might notably be present in the ferroalloys and/or pure elements used as raw materials. Nitrogen can also be introduced during atomization. Their content is preferably controlled to avoid changing detrimentally the microstructure and/or to avoid increasing the brittleness. Therefore, their content is respectively limited to 0.013%, to 0.015%, to 0.200% and to 0.100%.

The powder is first obtained by mixing and melting pure elements and/or ferroalloys as raw materials. It can also be obtained by using a pre-alloyed ingot of the targeted composition.

Ferroalloys refer to alloys of iron with a high proportion of one or more other elements such as manganese, silicon, aluminum, molybdenum, et cetera. Alloying elements can be alternatively added as pure elements (usually with a purity over 99 wt. %). Pure elements can notably be carbon and pure metals such as iron, molybdenum, aluminum, manganese, boron, nickel, zirconium, titanium, tantalum, tungsten, niobium, vanadium, chromium. The person ordinary skilled in the art knows how to mix different ferroalloys and pure elements to reach a targeted composition.

Once the composition has been obtained by the mixing of the pure elements and/or ferroalloys or scraps in appropriate proportions, the composition is heated at a temperature Th of at least 100° C. above its liquidus temperature and maintain at this temperature to melt all the raw materials and homogenize the melt in the atomization chamber.

Thanks to this overheating, the decrease in viscosity of the melted composition helps obtaining a powder with a high sphericity without satellites and with a proper particle size distribution. That said, as the surface tension increases with temperature, it is preferred not to heat the composition at a temperature more than 450° C. above its liquidus temperature. Preferably, the composition is heated at a temperature at least 200° C. above its liquidus temperature so as to promote the formation of highly spherical particles. More preferably, the composition is heated at a temperature 270° C. above its liquidus temperature.

Preferably, the composition is heated from 1500 to 1950° C. which represents a good compromise between viscosity decrease and surface tension increase.

The molten composition is then atomized into fine metal droplets by forcing a molten metal stream through an orifice, the nozzle, at moderate pressure and by impinging it with jets of gas (gas atomization). The gas is introduced into the metal stream just before it leaves the nozzle, serving to create turbulences as the entrained gas expands (due to heating) and exits into a large collection volume, the atomizing tower. The latter is filled with gas to promote further turbulences of the molten metal jet. The metal droplets cool down during their fall in the atomizing tower. Gas atomization is preferred over water atomization because it favors the production of powder particles having a high degree of roundness and a low number of satellites.

The atomization gas is preferably argon or nitrogen or a mixture thereof. They both increase the melt viscosity slower than other gases, e.g., helium, which promotes the formation of smaller particle sizes. They also control the purity of the chemistry and play a role in the good morphology of the powder. Finer particles can usually be obtained with argon than with nitrogen since the molar weight of nitrogen is 14.01 g/mole compared with 39.95 g/mole for argon. On the other hand, the specific heat capacity of nitrogen is 1.04 J/(g K) compared with 0.52 J/(g K) for argon. So, nitrogen increases the cooling rate of the particles. Preferably, argon is used to avoid the contamination of the composition by nitrogen, and formation of AlN.

The gas pressure is of importance since it directly impacts the particle size distribution. In particular, the higher the pressure, the higher the cooling rate. Preferably, the gas pressure is set from 10 to 30 bar, or even better from 20 to 30 bar, to promote the formation of particles whose size is most compatible with the additive manufacturing techniques.

The nozzle diameter has an impact on the molten metal flow rate and, thus, on the particle size distribution and on the cooling rate. The nozzle diameter is preferably limited to 4 mm to limit the increase in mean particle size and the decrease in cooling rate.

Optionally, the metal powder obtained by atomization can be dried, preferably at 100° C. in a vacuum chamber, to further improve its flowability.

The metal powder obtained by atomization can be either used as such or can be sieved to keep the particles whose size better fits the additive manufacturing technique to be used afterwards.

For example, in case of additive manufacturing by Laser Powder Bed Fusion, the range 20-63 μm (called fraction F2) is preferred and the range 20-45 μm is even better.

For Binder jetting, particles with fraction F1 having a size in the range below 20 μm, even below 10 μm, are used.

Fraction F3 covers particles size of 63 to 150 μm, or even 45 to 150 μm.

The parts according to the invention made of the metal powder can be obtained by additive manufacturing techniques such as Laser Powder Bed Fusion (LPBF), Direct metal laser sintering (DMLS), Electron beam melting (EBM), Selective heat sintering (SHS), Selective laser sintering (SLS), Laser Metal Deposition (LMD), Direct Metal Deposition (DMD), Direct Energy Deposition (DED), Direct Metal Laser Melting (DMLM), Direct Metal Printing (DMP), Laser Cladding (LC), Binder Jetting (BJ), Cold Spray (CS), Thermal Spray (TS), High Velocity Oxygen Fuel (HVOF).

Preferably, the invention can make use of LPBF process which is a layer upon-layer additive manufacturing technique. Thin layers of metal powder are evenly distributed using a coating mechanism onto a substrate platform, usually metal, that is fastened to an indexing table that moves in the vertical axis. This takes place inside a chamber containing a tightly controlled atmosphere. Once each layer has been distributed, each 2D slice of the part geometry is fused by selectively melting the powder. This is accomplished with a high-power laser beam, usually an ytterbium fiber laser. The laser energy is intense enough to permit full melting (welding) of the particles in the form of a track or strip. Basically, once a track is done, the process is repeated with the next track, which is separated from the first one by the hatch spacing. The process is repeated layer after layer until the part is complete.

The overhanging geometry is supported by nonmelted powder from previous layers. The main process parameters used in LPBF are usually the layer thickness, the hatch spacing, the scan speed and the laser power.

After completing the process, the left-over powder is screened to be reused.

The process for producing an additively manufactured part by LPBF comprises a first step of forming a powder layer with the powder according to the invention. Preferably the powder layer is less than 100 μm. Above 100 μm, the laser might not melt the powder in all the layer thickness, which might lead to porosity in the part. Preferably, the layer thickness is kept from 20 to 60 μm to optimize the melting of the powder.

In a second step, a focused laser beam forms a shaped layer by melting at least part of the powder layer in the process conditions detailed below. In the case of LPBF, each layer of the printed part is at least partially melted in an atmosphere substantially composed of an inert gas.

The printing parameters are the layer thickness, laser power, scan speed and hatch spacing. The combination of printing parameters is expressed as a sole parameter by using the volumetric energy density (VED). The VED is preferably from 60 to 380 J/mm3. VED is defined as P/(v·h·lt), where P is the laser power, v is the scan speed, h is the hatch spacing and lt is the powder layer thickness.

The laser power is preferably limited to maximum 550 W. Preferably, the laser power is set above 80 W to ease the melting in all the layer thickness. In a preferred embodiment, the laser power is from 150 to 300 W. The scan speed is preferably from 200 to 2000 mm/s and more preferably from 200 to 700 mm/s. Below 200 mm/s, the excess energy provided by the laser might lead key-hole porosity and/or to spatters which, if not properly drag outside of the powder bed, deposit on the powder layer which create voids in the printed part. Above 2000 mm/s, the energy provided by the laser to the powder might not be enough to melt the powder in all the layer thickness.

The hatch spacing is preferably from 0.05 to 0.12 mm. Below 0.05 mm, each point of the printed part might be remelted multiple times which might lead to overheating. Above 0.120 mm, non-melted powder might be trapped between two tracks. More preferably, the hatch spacing is from 0.07 to 0.12 mm.

The microstructure of the printed part according to the invention will now be described.

The printed part has a microstructure consisting of 5% to 50% of retained austenite, the rest being martensite and/or intercritical ferrite and/or bainite. Preferably the microstructure comprises of 5% to 30% of retained austenite. Martensite can be fresh martensite or tempered martensite or both and is preferably fresh martensite. During the LPBF process, each layer undergoes a heating and a cooling step during the melting of the layer with the previous one, implying different thermal path in each layer. During the subsequent printing layers, the microstructure can be heated in the intercritical domain (above Ac1 and below Ac3) or above and rapidly cooled.

The intercritical ferrite results from this heating step at a temperature between Ac1 and Ac3. The intercritical ferrite is different from the ferrite that could be formed by the transformation of austenite into ferrite and carbides during the cooling step, named hereinafter transformed ferrite.

Austenite is also formed during this heating step, when the temperatures reached are either above Ac3 or intercritical.

During cooling, a part of austenite is kept at ambient temperature, and a part is transformed into martensite, or bainite, thanks to the alloy design according to the invention, in particular manganese which increases the hardenability of the steel and suppresses the transformation of austenite into transformed ferrite and cementite.

The printed part according to the invention has a standard deviation of the nano-hardness values below or equal to 0.30 GPa.

Preferably, the part has an average nano-hardness above or equal to 4.0 GPa, depending on the carbon content.

The nano-hardness is measured according to Standard ISO14557.

Preferably the average nano-hardness is measured with at least 500 nanoindentations. More preferably with at least 800 nanoindentations, even more preferably with at least 1000 nanoindentations.

The printed parts according to the invention are manufactured in a robust way with respect to printing parameters. In particular, they have a variation of YS below or equal to 100 MPa, this variation of YS being calculated as the difference between the maximum value of YS and the minimum value of YS measured in at least two parts printed with different VED.

### EXAMPLES

The following examples and tests presented hereunder are non-restricting in nature and must be considered for purposes of illustration only. They will illustrate the advantageous features of the present invention, the significance of the parameters chosen by inventors after extensive experiments and further establish the properties that can be achieved by the metal powder according to the invention.

### Table 1—Compositions

The tested metal compositions are gathered in the following table wherein the element contents are expressed in weight percent and were first obtained by mixing and melting ferroalloys and pure elements.

| Pow- | | | | | | | | | |
|---|---|---|---|---|---|---|---|---|---|
| der | C | Mn | Al | Mo | Si | O | Ti | B | Fe |
| A | 0.14 | 4.03 | 0.87 | 0.21 | — | — | — | — | Balance |
| B | 0.14 | 3.97 | 0.78 | 0.20 | — | 0.04 | — | — | Balance |
| C | 0.09 | 3.93 | 0.01 | 0.22 | 0.01 | 0.03 | — | — | Balance |
| D | 0.31 | 2.66 | — | — | 2.85 | 0.03 | — | — | Balance |
| E | 0.12 | 1.78 | 0.01 | — | 0.38 | 0.03 | — | — | Balance |
| F | 0.28 | 0.13 | — | — | 3.03 | 0.02 | — | — | Balance |
| G | 0.08 | 3.56 | 0.01 | 0.01 | 0.01 | 0.05 | — | — | Balance |
| H | 0.12 | 6.61 | 0.77 | 0.21 | 0.01 | 0.05 | — | — | Balance |
| I | 0.12 | 3.58 | 0.58 | 0.17 | 0.01 | 0.03 | 0.02 | 0.004 | Balance |

Underline values: not according to the invention
P, S and N were respectively maintained below 0.013 wt. %, 0.015 wt. % and 0.200 wt %.

### Table 2—Atomization Parameters

The metal compositions were heated up to a temperature Th, corresponding to an overheating above the liquidus temperature of ΔTo, and were then gas atomized with argon, with a nozzle diameter of 2.5 mm, in the following process conditions:

| | Th | ΔTo | Gas pressure |
|---|---|---|---|
| Powder | (° C.) | (° C.) | (bar) |
| A | 1512 | 288 | 25 |
| B | 1800 | 288 | 25 |
| C | 1777 | 270 | 22 |
| D | 1724 | 270 | 22 |
| E | 1670 | 150 | 27 |
| F | 1733 | 270 | 22 |
| G | 1777 | 270 | 24 |
| H | 1769 | 270 | 24 |
| I | 1800 | 288 | 24 |

Underline values: not according to the invention

The powders are then sieved and classified into F1 to F3 fractions. Their flowability, sphericity and roundness were evaluated and found satisfying for additive manufacturing use. The tap density of the powders measured by standard B527-15 was around 4.5±0.1 g/cm3.

### Table 3—Printing Parameters

The powders A and E were then used to print a series of cubes of 1 cm3 by LPBF using the following parameters:

| | | | Layer | Laser | Scan | Hatch |
|---|---|---|---|---|---|---|
| | | VED | thickness | power | speed | spacing |
| Cubes | Powder | (J/mm3) | (mm) | (W) | (mm/s) | (mm) |
| 1 | A | 114 | 0.04 | 200 | 400 | 0.11 |
| 2 | E | 204 | 0.02 | 200 | 700 | 0.07 |

The cubes were then evaluated, and the corresponding microstructure determined, in surface fraction, is gathered in table 4.

### Table 4—Microstructure of the Printed Cubes

| | | Martensite + | | |
|---|---|---|---|---|
| | Retained | ferrite + | Presence | Presence of |
| | austenite | bainite (%) | of | transformed |
| Cubes | (%) | intercritical | cementite | ferrite |
| 1 | 8 | Balance | No | No |
| 2 | 4 | Balance | Yes | Yes |

Underlined values: not corresponding to the invention

The surface fractions of phases in the microstructure are determined through a specimen cut from printed parts and polished.

The determination of the volume fraction of retained austenite is performed thanks to X-ray diffraction (XRD).

The identification of the balance phase of the trials according to the invention and for the trials not according to the invention, i.e intercritical ferrite, transformed ferrite, bainite, fresh martensite, tempered martensite and cementite is performed by combination of different methods.

The intercritical ferrite is different from the “transformed ferrite” that could be created after the annealing, which is in particular enriched in carbon and manganese, i.e. carbon and manganese contents are higher than the carbon and manganese contents of the intercritical ferrite. The intercritical ferrite and the transformed ferrite can therefore be differentiated by observing a micrograph with a FEG-SEM microscope, after etching with Nital or Picral/Nital reagent. On such micrograph, the intercritical ferrite appears in medium grey, whereas the transformed ferrite appears in dark grey, owing to its higher carbon and manganese contents. Through FEG-SEM observations after Nital or Picral/Nital reagent etching, fresh martensite appears in light grey. Cementite may be identified as bright spots, but their fineness rends their identification difficult with such technic.

The confirmation of cementite presence was done thanks to a transmission Electron Microscope (TEM). Indeed, with such technic, crystallographic identification of the phases is possible without any doubt. Moreover, the presence of tempered martensite and bainite has also be assessed with TEM observations.

Finally, EBSD system coupled with SEM/FEG and TEM was a complementary technic used to identify the different phases and particularly intercritical ferrite and bainite as they exhibit different misorientation angle distributions.

For the trial according to the invention, during the successive heating and cooling steps of the printed layers, austenite and intercritical ferrite are formed during the intercritical annealing, and austenite is not transformed into transformed ferrite and cementite during cooling thanks to the content of manganese in the cube 1. A part of austenite is transformed to martensite below the Ms temperature at the end of the cooling steps. The microstructure is thus homogeneous, with contains only retained austenite, intercritical ferrite and martensite.

In the cube 2 printed with a powder having a manganese content lower than the one needed for the invention, the austenite and fresh martensite is more easily decomposed into transformed ferrite and cementite, and tempered martensite can also be formed. The content of cementite is below 1% in surface fraction.

### Table 5—Nano-Hardness Values of the Cubes

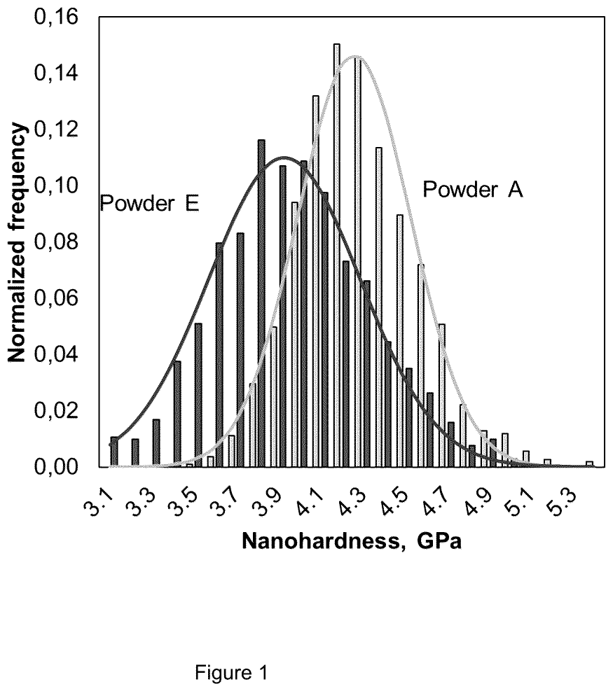

The nano-hardness values in the cubes have been measured at the center of the cube in two squares of 100*100 μm² for cube 1, and three squares of 100*100 μm² for cube 2 through nano indentation method following ISO14557 standard. Load applied was 3.50 mN with a loading rate of 0.2 mN/s and an unloading rate of 0.5 m/s. Dwell period at maximum load was 10 s. Spacing between indents was 4 μm. It corresponds to 1084 nanoindentations done in cube 1, and 1711 in cube 2. FIG. 1 illustrates the normalized frequency and the gaussian fit of the nano-hardness values of the printed parts.

The average nano-hardness is then calculated, and the standard deviation of the nano-hardness values are evaluated, and are gathered in the following Table 5:

| | | Average | |
|---|---|---|---|
| | Standard | nano- | |
| | deviation | hardness | CV |
| Cubes | (GPa) | (GPa) | (%) |
| 1 | 0.28 | 4.24 | 6.6 |
| 2 | 0.37 | 3.91 | 9.5 |

As seen in FIG. 1, the nano-hardness distribution is narrower for the cube 1, and is numerically reflected in Table 5 by both the standard deviation and the coefficient of variation (CV), which is the ratio between the standard deviation in GPa over the average nano-hardness in GPa. The content of manganese contributes to the austenite stabilization and thus to keep a homogeneous microstructure.

The powders having compositions according to table 1 are then used to print by LPBF series of 15 rectangular subsize tensile specimens (according to standard ASTM E8/E8M), by using the parameters gathered in table 6, and with a layer thickness of 20 μm.

### Table 6: Printing Parameters of Tensile Specimens

| | | | Laser | Scan | Hatch |
|---|---|---|---|---|---|
| Printed | | VED | Power | speed | spacing |
| parts | Powder | (J/mm³) | (W) | (mm/s) | (m) |
| 1 | B | 159 | 175 | 500 | 0.11 |
| 2 | B | 194 | 175 | 500 | 0.09 |
| 3 | B | 222 | 200 | 500 | 0.09 |
| 4 | B | 278 | 150 | 300 | 0.09 |
| 5 | B | 324 | 175 | 300 | 0.09 |
| 6 | C | 159 | 175 | 500 | 0.11 |
| 7 | C | 194 | 175 | 500 | 0.09 |
| 8 | C | 222 | 200 | 500 | 0.09 |
| 9 | C | 278 | 150 | 300 | 0.09 |
| 10 | C | 324 | 175 | 300 | 0.09 |
| 11 | D | 159 | 175 | 500 | 0.11 |
| 12 | D | 194 | 175 | 500 | 0.09 |
| 13 | D | 222 | 200 | 500 | 0.09 |
| 14 | D | 278 | 150 | 300 | 0.09 |
| 15 | D | 324 | 175 | 300 | 0.09 |
| 16 | E | 159 | 175 | 500 | 0.11 |
| 17 | E | 194 | 175 | 500 | 0.09 |
| 18 | E | 222 | 200 | 500 | 0.09 |
| 19 | E | 278 | 150 | 300 | 0.09 |
| 20 | E | 324 | 175 | 300 | 0.09 |
| 21 | F | 159 | 175 | 500 | 0.11 |
| 22 | F | 194 | 175 | 500 | 0.09 |
| 23 | F | 222 | 200 | 500 | 0.09 |
| 24 | F | 278 | 150 | 300 | 0.09 |
| 25 | F | 324 | 175 | 300 | 0.09 |
| 26 | G | 159 | 175 | 500 | 0.11 |
| 27 | G | 194 | 175 | 500 | 0.09 |
| 28 | G | 222 | 200 | 500 | 0.09 |
| 29 | G | 278 | 150 | 300 | 0.09 |
| 30 | G | 324 | 175 | 300 | 0.09 |
| 31 | H | 159 | 175 | 500 | 0.11 |
| 32 | H | 194 | 175 | 500 | 0.09 |
| 33 | H | 222 | 200 | 500 | 0.09 |
| 34 | H | 278 | 150 | 300 | 0.09 |
| 35 | H | 324 | 175 | 300 | 0.09 |
| 36 | I | 194 | 175 | 500 | 0.09 |
| 37 | I | 222 | 200 | 500 | 0.09 |
| 38 | I | 278 | 150 | 300 | 0.09 |
| 39 | I | 324 | 175 | 300 | 0.09 |

For a same composition of powder, parts are printed with different printing parameters, in particular with different power, speed and hatch distance leading to different VED. Three tensile specimens were printed and tested for each set of parameters, and the YS is measured according to ASTM E8/E8M. The average YS is then calculated from the three obtained YS values.

For a same chemical composition, the variation of YS, calculated by the difference between the maximum average YS and the minimum average YS measured, is gathered in Table 7.

### Table 7—Mechanical Properties of Printed Parts

| | Average | Variation |
|---|---|---|
| Printed | YS | of |
| parts | (MPa) | YS |
| 1 | 878 | 67 |
| 2 | 890 | |
| 3 | 897 | |
| 4 | 860 | |
| 5 | 830 | |
| 6 | 932 | 39 |
| 7 | 927 | |
| 8 | 935 | |
| 9 | 919 | |
| 10 | 896 | |
| 11 | 831 | 78 |
| 12 | 889 | |
| 13 | 845 | |
| 14 | 909 | |
| 15 | 906 | |
| 16 | 1015 | 201 |
| 17 | 878 | |
| 18 | 829 | |
| 19 | 849 | |
| 20 | 814 | |
| 21 | 1017 | 170 |
| 22 | 968 | |
| 23 | 963 | |
| 24 | 924 | |
| 25 | 847 | |
| 26 | 943 | 53 |
| 27 | 947 | |
| 28 | 935 | |
| 29 | 919 | |
| 30 | 894 | |
| 31 | 647 | 63 |
| 32 | 651 | |
| 33 | 659 | |
| 34 | 710 | |
| 35 | 693 | |
| 36 | 955 | 63 |
| 37 | 921 | |
| 38 | 919 | |
| 39 | 892 | |

Underline values: above the targeted ranges

The samples printed with a powder according to the invention (1-5, 6-10, 11-15 and 26-39) are less sensitive to a variation in VED, as seen with the small variation in the YS values obtained and highlighted by the variation of YS. The microstructures in these printed parts are then more robust. The manganese contributes to reducing the sensitivity of the microstructure to the energy input (i.e., VED) as well as the heating and cooling steps, improving thereby the robustness of the printing process

The samples printed with a low manganese powder 16-20 and 21-25 have a range of YS values much higher than those according to the invention. These samples are more sensitive to the printed parameters and VED, because of the low manganese content. The printed parts obtained have more heterogeneous properties.

What is claimed is:

1.-9. (canceled)

10. A metal powder having a composition comprising the following elements, expressed in content by weight:
$$C : 0.03 - 0.6 \%$$
$$Mn : 2.5 - 12. \%$$
$$O \leq 0.1 \%$$
$$P \leq 0.013 \%$$
$$S \leq 0.015 \%$$
$$N \leq 0.2 \%$$
and optionally one or more of the following elements, in weight percentage:
$$Al \leq 1. \%$$
$$Mo \leq 0.65 \%$$
$$B : \leq 0.004 \%$$
$$Si \leq 3 \%$$
$$Ti \leq 0.2 \%$$
$$Nb \leq 0.2 \%$$
$$V \leq 0.3 \%$$
$$Sn \leq 0.1 \%$$
$$Sb \leq 0.1 \%$$
$$Ni \leq 1. \%$$
$$Cr \leq 1. \%$$
$$Cu \leq 1. \%$$
a remainder of the composition being iron and unavoidable impurities resulting from processing.

11. The metal powder as recited in claim 10 wherein the average particle size ranks from 1 to 150 μm.

12. A process for manufacturing the metal powder as recited in claim 10 wherein, comprising:
a) melting elements or metal-alloys at a temperature Th at least 100° C. above the liquidus temperature to obtain the composition in molten form to define a molten composition; and
b) atomizing the molten composition through a nozzle with a gas pressurized from 10 to 30 bar.

13. A printed part, made of a metal powder having a composition comprising, by weight percent:
$$C : 0.03 - 0.6 \%$$
$$Mn : 2.5 - 12. \%$$
$$O \leq 0.1 \%$$
$$P \leq 0.013 \%$$
$$S \leq 0.015 \%$$
$$N \leq 0.2 \%$$
and optionally one or more of the following elements, in weight percentage:
$$Al \leq 1. \%$$
$$Mo \leq 0.65 \%$$
$$B \leq 0.004 \%$$
$$Si \leq 3 \%$$
$$Ti \leq 0.2 \%$$
$$Nb \leq 0.2 \%$$
$$V \leq 0.3 \%$$
$$Sn \leq 0.1 \%$$
$$Sb \leq 0.1 \%$$
$$Ni \leq 1. \%$$
$$Cr \leq 1. \%$$
$$Cu \leq 1. \%$$
a remainder of the composition being iron and unavoidable impurities resulting from the elaboration,
the printed part having a microstructure consisting, in surface fraction,
from 5 to 50% of retained austenite, and
a rest being martensite or intercritical ferrite or bainite.

15. The printed part as recited in claim 14 wherein the printed part has a standard deviation of the average nano-hardness values below or equal to 0.30 GPa.

16. A process for manufacturing the printed part as recited in claim 14, comprising the following steps:
providing the metal powder; and
printing by Laser Powder Bed Fusion.

17. The process as recited in claim 16 further comprising a first step of forming a powder layer with a thickness below 100 μm and a second step where a focused laser beam forms a shaped layer by melting at least part of the powder layer in an atmosphere composed of an inert gas.

18. The process as recited in claim 17 wherein the VED is from 60 to 380 J/mm3.

19. The process as recited in claim 18 wherein
the laser power is limited to maximum 550 W,
the scan speed is from 200 to 2000 mm/s, and
the hatch spacing is from 0.05 to 0.12 mm.
